(19) United States
(12) Patent Application Publication
(10) Pub. No.: US 2025/0025913 A1
(43) Pub. Date: Jan. 23, 2025

(54) PERFORMANCE IMPROVEMENT OF CEMENT-COATED WOOD PRODUCTS WITH INTERFACE BINDING AGENTS

(71) Applicant: LOUISIANA-PACIFIC CORPORATION, Nashville, TN (US)

(72) Inventors: Qining Sun, Franklin, TN (US); Richard McClintock, Cullman, AL (US); Tara Gutierrez, Archbold, OH (US); Chris Andrews, Signal Mountain, TN (US)

(21) Appl. No.: 18/777,084

(22) Filed: Jul. 18, 2024

Related U.S. Application Data
(60) Provisional application No. 63/527,365, filed on Jul. 18, 2023.
(60) Provisional application No. 63/644,438, filed on May 8, 2024.

(51) Int. Cl. B05D 7/06

(52) U.S. Cl. CPC B05D 7/06

(57) ABSTRACT

The present invention is directed to multi-layered building panel that includes: a lignocellulosic substrate layer with a first surface; an interface binding layer disposed on the first surface of the lignocellulosic substrate, wherein the interface binding layer includes a silane, a siliconate, an alkali silicate, or a combination thereof; and a cementitious coating layer disposed over the interface binding layer such that the interface binding layer is disposed between the cementitious coating layer and the first surface of the lignocellulosic substrate layer. Methods of creating a multi-layered building panel with a durable bond between the lignocellulosic substrate layer and the cementitious coating are also disclosed herein.

All patents, patent applications, and publications cited herein are hereby incorporated by reference in their entirety. The disclosures of these publications in their entireties are hereby incorporated by reference into this application in order to more fully describe the state of the art as known to those skilled therein as of the date of the invention described and claimed herein.

### FIELD OF INVENTION

This invention relates to the use of interface binding agents to enhance the interface adhesion between certain lignocellulosic material types and fire-resistant cement coatings.

### BACKGROUND

This section is intended to introduce various aspects of the art, which may be associated with exemplary embodiments of the present disclosure. This discussion is believed to assist in providing a framework to facilitate a better understanding of aspects of the present disclosure. Accordingly, it should be understood that this section should be read in this light, and not necessarily as admissions of prior art.

Fire retardant chemicals have been used to impregnate lignocellulose-based materials such as plywood, oriented strand board (OSB), and particleboard panels, in order to yield fire-resistant products. Fire retardant coatings have also been used to reduce the surface flammability and improve burn-through resistance of wood products, and other flammable materials. Compositions and uses for fire retardant coatings are discussed further in U.S. Pat. Nos. 5,130,184; 4,818,595; 4,661,398; and 4,572,862, each of which are incorporated by reference in their entireties. Application of fire retardant coatings can be accomplished in multiple ways, including, brushing, spraying and sheet lamination. A particularly beneficial system and method for efficiently coating substrates with fire retardant materials is disclosed in U.S. Pat. No. 7,595,092, which is incorporated by reference in its entirety. In U.S. Pat. No. 7,595,092, the dimensions and volume of the coating can be controlled while yielding a fire-resistant product that maintains a high degree of structural integrity over time, at high temperatures, and during exposure to high temperatures over extended periods.

While certain types of wood used in lignocellulose-based materials (e.g., plywood, OSB, and particleboard panels) are particularly suitable for generating a durable adhesion with fire-resistant materials using the methods discussed above, other wood types may yield reduced bonding performance. For instance, delamination and chipping away of the fire-resistant coating can be observed when wood such as southern yellow pine (SYP) is used as the lignocellulose-based material, particularly following extended exposure to moisture. Traditional binding agents that may be used to improve the adhesion between such wood products and the fire-resistant coatings can interfere with the fire-retardant properties of the final building panel. For instance, resin binders (e.g., phenolic resole, furan, melamine-formaldehyde, latex, polyesters, polyvinyl acetate, and silicone or amino or epoxy related thermoset and thermoplastic resins) would thicken the premix and clog transferring line and spray gun/atomizer. Such binders may also interrupt the cement curing/hardening, could generate surface defects (e.g., yellowing, blotches, pinholes, craters, etc.), and may compromise fire rating due to their inherent combustibility and flammability.

In addition, because many building products with greater or lesser fire-resistant qualities compete as commodities, production methods used to make such products must be efficient and rapidly scalable in volume. Production methods also need to yield consistent products that meet the standards of the applicable building code. Prior systems and method of applying fire-resistant materials can be commercially inefficient, requiring extended curing times or a heating process to ensure sufficient curing of the fire-resistant material to lignocellulose-based products. Further, prior systems and methods may result in the formation of pinholes in the surface of the final panel and cause reduced water resistance of the final product.

Thus, in view of the foregoing, an object of the present disclosure is to provide materials, systems, and processes that permit heighted bonding of a fire-resistant material, such as a fire-resistant cementitious coating, to lignocellulose-based products without adversely affecting the fire-resistance or performance of the final layered panel product. Another objective of this disclosure is to provide for a substantially smooth surface of the final product with an increased water resistance and improved overall performance.

### BRIEF SUMMARY

In various aspects, the present disclosure relates to a multi-layered building panel. The multi-layered building panel can comprise: a lignocellulosic substrate layer with a first surface; an interface binding layer comprising an interface binding agent, and the interface binding layer being disposed on the first surface of the lignocellulosic substrate. In embodiments, the interface binding agent comprises a silane, a siliconate, an alkali silicate, or a combination thereof. The multi-layered building panel can further comprise a cementitious coating layer disposed over the interface binding layer such that the interface binding layer is disposed between the cementitious coating layer and the first surface of the lignocellulosic substrate layer.

In embodiments, the lignocellulosic substrate layer comprises southern yellow pine.

In one embodiment, the cementitious fire-resistant layer comprises an intermixed interface binding agent, the intermixed interface binding agent comprising a silane, a siliconate, an alkali silicate, or a combination thereof.

In certain embodiments, the concentration of interface binding agent within the interface binding layer is about 50 wt. % or less. The concentration of interface binding agent within the interface binding layer can be between about 50 wt. % and about 10 wt. %.

In embodiments, the lignocellulosic substrate comprises a second surface, and the multi-layered building panel further comprises a second interface binding layer that is disposed on the second surface of the lignocellulosic substrate. The panel can further comprise a second cementitious coating layer disposed on the second interface binding layer such that the second interface binding layer is disposed between the second cementitious coating layer and the second surface lignocellulosic substrate layer.

In certain embodiments, the cementitious fire-resistant coating comprises magnesium oxychloride. The cementitious fire-resistant coating can be disposed within a carrier veil web.

Another aspect of the present invention includes a multi-layered fire-resistant lignocellulosic panel. In various embodiments, the fire-resistant building panel comprises a first layer, wherein the first layer comprises a lignocellulosic substrate. The fire-resistant lignocellulosic panel can further comprise a second layer wherein the second layer comprises a cementitious binding agent slurry. In embodiments, the cementitious binding agent slurry comprises a cementitious fire-resistant coating and an interface binding agent.

In certain embodiments, the multi-layered fire-resistant lignocellulosic panel further includes a third layer that comprises an interface binding layer, the interface binding layer being disposed between the first and second layers.

In embodiments, the concentration of interface binding agent within the second layer is less than about 5 wt. %. The concentration of interface binding agent within the second layer can be less than about 1 wt. %.

In yet another aspect, a method of creating a lignocellulosic panel with a cementitious coating that is resistant to delamination is disclosed herein. In embodiments, the method comprises a step of depositing an interface binding layer onto at least one surface of the lignocellulosic panel. The interface binding layer can comprise an interface binding agent that is selected from the group consisting of a silane, a siliconate, an alkali silicate, or a combination thereof. The method can further comprise depositing a cementitious coating layer over the interface binding layer such that the interface binding layer is disposed between the cementitious coating layer and the lignocellulosic panel. In embodiments, the method includes permitting the cementitious coating layer to cure onto the lignocellulosic panel. In certain embodiments, the lignocellulosic panel comprises southern yellow pine. The cementitious coating layer can comprise an intermixed interface binding agent, the intermixed interface binding agent comprising a silane, a siliconate, an alkali silicate, or a combination thereof.

### BRIEF DESCRIPTION OF THE DRAWINGS

Certain illustrations, charts, or flow charts are provided to allow for a better understanding for the present invention. It is to be noted, however, that the drawings illustrate only selected embodiments of the inventions and are therefore not to be considered limiting of scope. Additional and equally effective embodiments and applications of the present invention exist.

FIG. 1 shows an exploded view of an inorganic-organic complex binding system under one embodiment of the present disclosure. A sandwiched, multi-layer structure can be seen with a cement coating, reinforcing additives and fillers, surface penetrating sealers, and interface adhesion promoters (also referred to herein as coupling agents or binding agents), and wood-based substrates to deliver multifunctional building material.

FIG. 2 shows an exploded view of an inorganic-organic complex binding system under another embodiment of the present disclosure. A multi-layer structure can be seen wherein the interface binding agents are mixed with a cement coating prior to application of the coating onto the substrates to deliver multifunctional building material.

FIG. 3 shows an exploded view of an inorganic-organic complex binding system under an additional embodiment of the present disclosure. A sandwiched, multi-layer structure can be seen wherein the interface binding agents are applied to the substrate surface prior to application of the cement coatings, such that cement coatings are applied on top of the interface binding agents to deliver multifunctional building material.

FIG. 4 provides a schematic flow diagram showing the general process for coating a wood substrate using an inorganic-organic complex binding system pursuant to one embodiment of the present disclosure.

FIG. 5 provides a schematic flow diagram showing an exemplary process for creating a coated building panel with a durable adhesion between the lignocellulosic substrate and cementitious coating in another embodiment of disclosed inorganic-organic complex binding system.

### DETAILED DESCRIPTION OF EXEMPLARY EMBODIMENTS

Detailed descriptions of one or more embodiments are provided herein. It is to be understood, however, that the present invention can be embodied in various forms. Therefore, specific details disclosed herein are not to be interpreted as limiting, but rather as a basis for the claims and as a representative basis for teaching one skilled in the art to employ the present invention in any appropriate manner.

### Abbreviations and Definitions

Unless otherwise defined, all technical and scientific terms used herein have the same meaning as commonly understood by one of ordinary skill in the art to which this disclosure belongs. The present disclosure may be embodied in other specific forms without departing from the spirit or essential attributes thereof, and it is therefore desired that the embodiments of the disclosure be considered in all aspects as illustrative and not restrictive. Any headings utilized in the description are for convenience only and no legal or limiting effect. Numerous objects, features, and advantages of the embodiments set forth herein will be readily apparent to those skilled in the art upon reading of the following disclosure when taken in conjunction with the accompanying drawings.

The singular forms “a,” “an,” and “the” include plural reference unless the context clearly dictates otherwise. The use of the word “a” or “an” when used in conjunction with the term “comprising” in the claims and/or the specification can mean “one,” but it is also consistent with the meaning of “one or more,” “at least one,” and “one or more than one.”

Wherever any of the phrases “for example,” “such as,” “including” and the like are used herein, the phrase “and without limitation” is understood to follow unless explicitly stated otherwise. Similarly, “an example,” “exemplary” and the like are understood to be nonlimiting.

The term “substantially” allows for deviations from the descriptor that do not negatively impact the intended purpose. Descriptive terms are understood to be modified by the term “substantially” even if the word “substantially” is not explicitly recited. Therefore, for example, the phrase “wherein the lever extends vertically” means “wherein the lever extends substantially vertically” so long as a precise vertical arrangement is not necessary for the lever to perform its function.

The terms “comprising” and “including” and “having” and “involving” (and similarly “comprises,” “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a process involving steps a, b, and c” means that the process includes at least steps a, b, and c. Wherever the terms “a” or “an” are used, “one or more” is understood, unless such interpretation is nonsensical in context.

As used herein the term “about” is used herein to mean approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

References in the specification to “one embodiment,” “an embodiment,” “an exemplary embodiment,” etc., indicates that the embodiment described can include a particular feature, structure, or characteristic, but every embodiment may not necessarily include such feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The phrase “synergistic effects,” “synergism,” or a combination thereof can be used herein in reference to situations where the combined action of the recited elements or factors produces a result that is greater than the sum of their individual effects. Thus, when such elements or factors work together, they amplify each other's impact, leading to a more significant outcome than what would be expected if each acted independently.

The word “organic,” as used herein refers to natural materials, process, or substances that are derived from or produced by living organisms.

“Lignocellulose-based” or “lignocellulose-based” may be used interchangeable herein in reference to materials, products, or substances that are primarily composed of lignocellulosic materials or derived from lignocellulosic biomass. Lignocellulose is plant biomass that consists of cellulose, hemicelluloses, and lignin, in which cellulose can refer to a natural polymer found in the cell walls of plants.

“Wood,” as used herein can refer to a lignocellulosic material that comprises cellulose fibers embedded in a carbohydrate-lignin matrix.

“Alkali silicate” as used herein can refer to chemical compounds comprising silicon dioxide (SiO₂) and an alkali metal oxide. Non-limiting examples of alkali silicates include sodium silicate (Na₂SiO₃), potassium silicate (K₂SiO₃), and lithium silicate (Li₂SiO₃). Certain alkali silicates can be provided or obtained in the form of an alkali silicate solution. Exemplary alkali silicate solutions comprise sodium silicate, potassium silicate, lithium silicate, or a combination thereof.

“Silicates” can refer to any salts and esters of silicic acid. Silicates can be alkali metal silicates (e.g., sodium, potassium, calcium, magnesium, lithium, aluminum, barium, zirconium silicates, etc.) or organic silicates such as esters of mono- and di-silicic acid that can be produced synthetically.

“Siliconates” can refer to chemical compounds wherein silicon is covalently bonded to oxygen atoms. In certain embodiments, siliconates further comprise at least one cation or other organic groups (e.g., sodium, potassium, ethyl groups, etc.). Siliconates can be any salts of organic silicon substance, or organic modified alkali silicates. Siliconates can be alkali metal siliconates (e.g., sodium, potassium, calcium, magnesium, lithium siliconates, etc.) or alkali metal alkyl siliconates. Non-limiting examples of siliconates include sodium methyl siliconate, potassium methyl siliconate, lithium methyl siliconate, and disodium carboxyethyl siliconate.

The term “firer-resistant,” as used herein, encompasses any type of fire barrier substance, such as fire retardants, flame retardants, and flame-resistant materials that can be prepared in the form of a slurry. Fire-resistant (“FR”) coatings include, but are not limited to, Pyrotite® (Louisiana-Pacific Corporation, Tennessee, USA), a magnesium oxychloride material with filler, and other similar substances, (e.g., magnesium oxychloride and/or magnesium oxysulphate or the like without filler). In embodiments, FR coatings are cementitious materials that provide fire barrier protection and may be used to coat substrates, according to embodiments disclosed herein. Specific chemistries of fire barrier or fire-resistant materials that provide fire protection, which may be used in accordance with the systems and methods of the present invention, are described in U.S. Pat. Nos. 4,572,862; 4,818,595; 5,039,454; and 7,95,092, which are hereby incorporated by reference in their entireties. Certain fire-resistant coatings contain 3-7 molar magnesium oxychloride. The fire-resistant coating or substance may include a wet slurry that is a precursor to magnesium oxychloride, or a wet slurry that is a precursor to magnesium oxysulphate, or combinations of both. For example, when the magnesium oxychloride-based fire-resistant substance completes its curing process, the compound is magnesium oxychloride having the formulation: MgCl₂·mMg(OH)₂·nH₂O, where m is between about 3 and about 7, and n is between about 6 and about 10, as determined by x-ray diffraction or x-ray phased analysis. Alternatively, m may be about 5 and n may be about 8. FR coatings can be between about 10 to about 125 mm thick, and can include a filler such as inert sand, gravels, crushed rocks, silica flour, pumice, vermiculite, volcanic ash, per lite, wood shavings, and/or mineral fibers. The thickness of the coating on the substrate varies according to the level of fire resistance desired in a particular application, and the filler in the slurry varies depending on desired handling qualities during manufacturing and resulting product characteristics. Substrates that may be coated with fire-resistant materials may include, for example, wood, plywood, OSB, plastic, metals, wallboard, medium density fiberboard (MDF), and particle board, or any material or composite material suitable for coating. Typical substrates may take the form of a planar sheet, such as a 4-foot by 8-foot panel, but smaller and/or larger substrates are also equally possible.

As used herein, the terms “impregnate,” “coat,” and the like encompasses any degree, level, or amount of intake of solution or slurry into or upon a surface (such as a porous carrier material, a pre-coated surface, or a substrate), such as via saturation or dispersion with some entrained air or surface coating.

As used herein, “curing” can refer to the process of converting an interface binding solution, a cementitious slurry, or both into a solid. Curing can be generally achieved through thermal treatment and/or exposure to ambient conditions over time. Partial curing means that the slurry has partially solidified. Subsequent to the steps for coating substrates, processes for further treating coatings on the substrates may include heat treatment. Heat treatment initiates and/or accelerates the curing processes of the coatings but may also drive off water that contributes to fire resistance. Controlling the amount of heat a coated substrate is exposed to may allow for controlling curing and water loss. Both the curing rate and water content of interface binding solutions, fire-resistant layers, or both should be within acceptable ranges in order to produce efficiently a fire-resistant substrate having a specified amount of fire-resistant material with the requisite properties. An oven may provide controlled heat treatment in which substrates pass through the oven along a series of rollers, for example. Factors that may be controlled in an oven may include temperature, humidity, intensity of heating units, air speed and transport speed.

### Description of Selected Embodiments

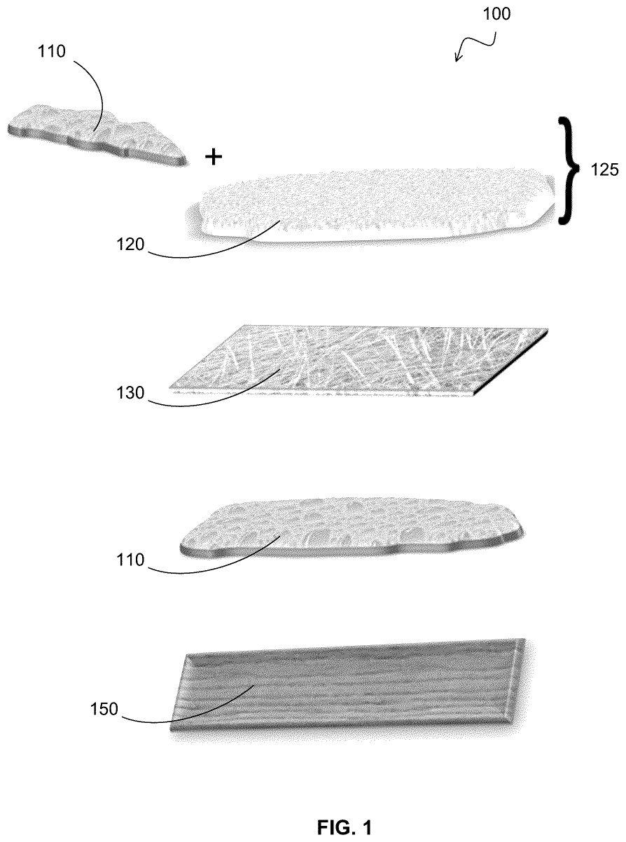

In various exemplary embodiments, as seen in FIGS. 1-5, the present invention comprises an inorganic-organic complex binding system and related methods for enhancing the bonding strength between a substrate and cement coatings. In embodiments, the cement coating can comprise an FR coating or an FR-resistant material. The substrate can comprise an inorganic substrate, an organic substrate, or a combination thereof. The substrate can be an organic substrate. The substrate can comprise a wood substrate. In embodiments, the organic substrate comprises a manufactured wood product. The manufactured wood product can be derived from a hardwood tree, a softwood tree, or a combination thereof. In certain embodiments, the organic substrate comprises a pine tree. Non-limiting examples of pine trees include, but are not limited to Eastern White Pine (Pinus strobus), Ponderosa Pine (Pinus ponderosa), Scots Pine (Pinus sylvestris), Lodgepole Pine (Pinus contorta), Longleaf Pine (Pinus palustris), Sugar Pine (Pinus lambertiana), Virginia Pine (Pinus virginiana), Pitch Pine (Pinus rigida), Red Pine (Pinus resinosa), Yellow Pine, Western White Pine (Pinus monticola), Jack Pine (Pinus banksiana), Mugo Pine (Pinus mugo), Black Pine (Pinus nigra), Bristlecone Pine (Pinus longaeva), Aleppo Pine (Pinus halepensis), Coulter Pine (Pinus coulteri), Sugar Pine (Pinus lambertiana), and Korean Pine (Pinus koraiensis). The organic substrate can comprise southern yellow pine (SYP). SYP, as used herein can refer to any species of pine trees found in the southern or southeaster United States. Non-limiting examples of SYP include Loblolly Pine (Pinus taeda), Longleaf Pine (Pinus palustris), Slash Pine (Pinus elliottii), and Shortleaf Pine (Pinus echinata).

FIG. 1 shows an exploded view of an inorganic-organic complex binding system 100 under one embodiment of the present disclosure. A sandwiched, multi-layer structure 100 can be seen with a cement coating 120, reinforcing additives and fillers 130, and interface binding agents (also referred to herein as coupling agents or interface adhesion promoters) 110, and lignocellulose-based substrates 150 to deliver multifunctional building material 100. In embodiments, the multi-layered structure 100 comprises a lignocellulose-based substrate 150 with an interface binding agent 110 disposed on at least one surface. A cementitious coating 120 can be disposed on top of the interface binding agent 110 such that the interface binding agent 110 is disposed between the cementitious coating 120 and the lignocellulose-based substrate 150. As shown in FIG. 1, the cement coating 120 can be impregnated within or otherwise disposed upon an optional layer of reinforcing additives and fillers 130. In embodiments, the reinforcing additives and fillers 130 comprise web or veil of materials (also referred to as a “carrier veil web”) onto which the cement coating is disposed 120. In embodiments, the carrier veil web 130 comprises fiberglass. Alternatively, the cement coating 120 can be directly applied to the interface binding agent 110 without the use of any reinforcing additives or fillers 130. As can be seen, the interface binding agents 110 can be either applied directly to at least one surface of the lignocellulose-based substrate 150, premixed with the cementitious coating 120 to create a cementitious binding agent slurry 125, or a combination thereof.

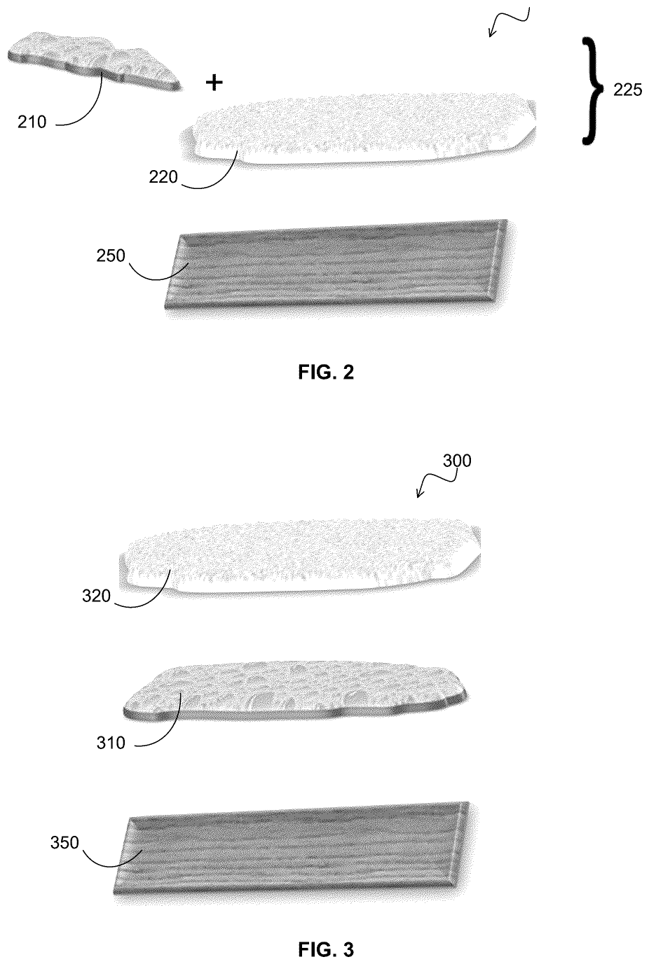

FIG. 2 shows an exploded view of an inorganic-organic complex binding system 200 under another embodiment of the present disclosure. A multi-layer structure 200 can be seen wherein the interface binding agents 210 are mixed with a cement coating 220 to form a cementitious binding agent slurry 225 prior to application of the coating onto the at least one surface of a lignocellulose-based substrate 250 to deliver multifunctional building material 200, such as a building panel. Thus, the embodiment of FIG. 2 results in a two-layered structure 200 that comprises a lignocellulose-based substrate 250 with a cementitious binding agent layer 225, wherein the cementitious binding agent layer 225 comprise a cement coating 220 that further comprises an interface binding agent 210. In certain embodiments, the cementitious binding agent layer 225 can be impregnated within or otherwise disposed upon reinforcing additives and fillers (seen at 130 in FIG. 1).

FIG. 3 shows an exploded view of an inorganic-organic complex binding system 300 under an additional embodiment of the present disclosure. A sandwiched, multi-layer structure 300 can be seen wherein the interface binding agents 310 are applied to the lignocellulose-based substrate 350 surface prior to application of the cement coatings 320, such that cement coatings 320 are applied on top of the interface binding agents 310 (also referred to herein as “adhesion promoters”) to deliver multifunctional building material 300, such as a building panel. In embodiments, the multi-layered structure 300 comprises a lignocellulose-based substrate 350 with an interface binding agent 310 disposed on at least one surface. A cementitious coating 320 can be disposed on top of the interface binding agent 310 such that the interface binding agent 310 is disposed between the cementitious coating 320 and the lignocellulose-based substrate 350. In alternate embodiments, the cement coating 320 can be impregnated within or otherwise disposed upon an optional layer of reinforcing additives and fillers (seen at 130 of FIG. 1).

In the various embodiments disclosed herein the cement coating or cementitious coating comprises a fire-resistant material such that a fire-resistant manufactured wood product is formed. The fire-resistant manufactured-wood product according to any of the various embodiments disclosed herein can be produced by applying a fire-resistant cement coating and an interface binding agent to a manufactured-wood product, such as a panel or board manufactured from strands or flakes. Examples of manufactured-wood products include, but are not limited to, OSB, plywood, and particleboard panels. The strands or flakes may be obtained from a variety of tree or plant species, and the properties of the resultant manufactured-wood product can vary depending on the species used.

The panels disclosed herein can comprise a building panel. In certain embodiments, the panel is a roofing panel. The panel can be a wall panel. The panel can be a structural sheathing panel. The panel can comprise roof sheathing, wall sheathing, or a combination thereof.

When applied to a surface of a lignocellulose-based product such cementitious coatings can have varying bonding performance depending on the specific materials used. As an example, OSB using aspen as the lignocellulosic material source exhibits a strong, durable bonding performance with an applied fire-resistant cement coating. However, that same coating has reduced bonding performance for OSB manufactured using southern yellow pine (SYP). By way of example, delamination can occur, resulting in the cement coating chipping during installation, shortly after installation, during transportation of the OSB product, after an extended exposure to moisture and/or carbon dioxide, or a combination thereof.

Without being bound by theory, the reduced binding performance of cementitious coatings to certain wood types is due to certain properties of wood species. For instance, SYP has high extractive chemicals, increased lignin, and a highly hygroscopic hemicellulose as compared other wood types such as aspen. Additionally, SYP has lower ash content than aspen¹ and a lower pH than aspen², while the density of SYP is greater than that of aspen.² ¹Lenth. Christopher. “Wood Material Behavior in Severe Environments.” PhD diss., Virginia Tech²Tasdemir, Cagatay, and Hiziroglu, Salim. “Measurement of Various Properties of Southern Pine and Aspen as Function of Heat Treatment.” Measurement 49 (March 2014): 91-98.

As compared to SYP, Aspen's lower specific gravity (SG) results in a higher compaction ratio during a hot-pressing process³, leading to a more uniform profile in both vertical and horizontal density distribution. Without being bound by theory, such uniformity reduces thickness swell in aspen building panels (such as OSB panels), diminishing the effects of unbalanced internal stresses that may be observed in wood species with less uniform density distribution profiles (such as SYP). Furthermore, and without wishing to be bound by theory, ultrastructural changes during the hot-pressing process (e.g., crystalline allomorph and degree of crystallinity alteration, amorphous hemicellulose and lignin redeposition, wax/MDI distribution and porosity refill caused surface hydrophobicity discrepancies) can contribute to reduced bonding strength (chelation and hydrogen bonds) observed between SYP with magnesium oxychloride (MOC) cements, especially following exposure of the MOC-coated SYP panel to moisture over time.⁴ Thus, without being bound by theory, any one or more of the above-factors explains why certain wood types (such as SYP) are more prone to delamination from a cementitious coating over time or following exposure to moisture. ³Gu. Hongmei, et al., “Comparison Study of Thickness Swell Performance of Commercial Oriented Strandboard Flooring Products.” Forest Products Journal 55, no. 12 (December 2005): 239-245.⁴Maier A, Manea D L. “Perspective of Using Magnesium Oxychloride Cement (MOC) and Wood as a Composite Building Material: A Bibliometric Literature Review.” Materials 15(5) (February 2022): 1772

The present disclosure includes use of a coupling agent or binding agent as an adhesion promoter, a surface-penetrating sealer, a special primer, or a tie layer to enhance the interface adhesion (particularly the wet bonding when subjected to penetrating damp, carbon dioxide (CO₂), or a combination thereof, over the time) among various materials such as between a SYP manufactured-wood product and the FR cement coating. The interface binding agents act at the interface between the inorganic coating (i.e., fiberglass-reinforced magnesium oxychloride cement) and the organic substrate (i.e., OSB panels) to bond or couple the various dissimilar materials (e.g., cement, fiberglass, wood composite material).

In embodiments, the interface binding agent comprises silane, siliconate, an alkali silicate, or a combination thereof. In certain embodiments, use of an interface binding agent that comprises a combination of at least two components selected form the group consisting of an alkali silicate, a siliconate, and silane provides synergistic effects such that the combination results in improved adhesion performance as compared with interface binding agents that comprise only one of alkali silicate, siliconate, or silane.

In certain embodiments, alkali silicates also known as “water-glass,” which have an inorganic nature, can be incorporated into waterborne coating systems (e.g., architectural coating, concrete coating, cementitious coatings) to improve interface bonding strength among inorganic components (such as fire-resistant coatings) and organic components (such as lignocellulose-based products).

A silicate can act as a penetrating sealer made up of small particles that, in operation, can collectively serve as a sealant. These small silicate particles can be suspended with an alkali metal cation (e.g., sodium, potassium, lithium, etc.) carrier. In embodiments and without being bound by theory, the alkali metal cation helps transport the particles past the surface pores of the concrete or the cell wall of wood or wood-based composites.

Silicates concentration (based on 100% solids) within a cementitious binding agent slurry can range from about 0.1 wt. % to about 30.0 wt. % based on the total slurry weight (100% solids basis). In embodiments, the silicate concentration in the cementitious binding agent slurry ranges from about 0.5 wt. % to about 10.0 wt. %. In certain embodiments, the silicate concentration within the cementitious binding agent slurry is less than about 4.0 wt. %. The silicate concentration in the cementitious binding agent slurry can be about 0.5 wt. %.

Similar to silicate, siliconate can also act as a penetrating sealer made up of small particles that, in operation, can collectively serve as a sealant. Siliconate concentration (based on 100% solids) within the cementitious binding agent slurry can range from about 0.1 wt. % to about 30.0 wt. % based on the total slurry weight (100% solids basis). In embodiments, the siliconate concentration within the cementitious binding agent slurry ranges from about 0.5 wt. % to about 10.0 wt. %. In certain embodiments, the siliconate concentration within the cementitious binding agent slurry is less than about 1.0 wt. %. The siliconate concentration can be about 0.5 wt. %.

Examples of silane agents include, but are not limited to, epoxy one, amino, diamino, triamino, methacrylate, mercapto, vinyl, chloro, alkyl, styrylamine, silazane, and phenyl:

| Silane Type | Chemical Name |
|---|---|
| Amino | (3-Aminopropyl)trimethoxysilane; (3- |
| | Aminopropyl)triethoxysilane |
| Alkyl | Methyltrimethoxysilane; Ethyltrimethoxysilane |
| Chloro | (3-Chloropropyl)trimethoxysilane; (3- |
| | Chloropropyl)triethoxysilane |
| Diamino | N-(2-Aminoethyl)-3-aminopropyltrimethoxysilane; |
| | N-(2-Aminoethyl)-3-aminopropyltriethoxysilane |
| Epoxy | (3-Glycidyloxypropyl)trimethoxysilane; (3- |
| | Glycidyloxypropyl)triethoxysilane |
| Methacrylate | 3-Methacryloxypropyltrimethoxysilane; 3- |
| | Methacryloxypropyltriethoxysilane |
| Mercapto | (3-Mercaptopropyl)trimethoxysilane; (3- |
| | Mercaptopropyl)triethoxysilane |
| Phenyl | Phenyltrimethoxysilane; Phenyltriethoxysilane |
| Silazane | Hexamethyldisilazane |
| Styrylamine | Vinylbenzylaminoethylaminopropyltrimethoxysilane; |
| Triamino | (3-Trimethoxysilylpropyl)diethylenetriamine |
| Vinyl | Vinyltrimethoxysilane; Vinyltriethoxysilane |

Silane (based on 100% solids) concentrations within the cementitious binding agent slurry within the cementitious binding agent slurry ranges from about 0.05 wt. % to about 10.0 wt. %, based on the total slurry weight. In certain embodiments, silane concentration within the cementitious binding agent slurry is less than about 1.0 wt. %. The silane concentration within the cementitious binding agent slurry can be about 0.5 wt. %.

In certain embodiments the coupling agent or interface binding agent comprises an alkali silicate, a siliconate, a silane, or any combination thereof. By way of example, the coupling agent can comprise at least two of: an alkali silicate, a siliconate, and silane ((also referred to as “silane coupling agents” or “silane adhesion promoters”). In certain embodiments, the interface binding agent comprises one or more of an alkali silicate, a siliconate, and a silane mixed with or without water. The interface binding agent can comprise at least two of an alkali silicate, siliconate, and silane adhesion promotor mixed under varying weight ratios. In one embodiment, the ratio of silicate, siliconate, or both to silane (based on 100% solids) ranges from about 100:1 to about 1:20, inclusive. The ratio of silicate, siliconate, or both to silane can range from about 30:1 to about 1:5. Based on 100% solids, the ratio of silicate to siliconate in the interface binding agent ranges from about 100:1 to about 1:100. In embodiments, the alkali silicate, siliconate, silane adhesion promotor, or any combination thereof are mixed at room temperature. The alkali silicate, siliconate, silane adhesion promotor, or any combination thereof can be mixed under stirring for about one minute. In certain embodiments, alkali silicate, siliconate, silane adhesion promotor, or any combination thereof is mixed for up to about 5.0 hours.

The interface binding agent can be combined with a solution to form an interface binding solution. In embodiments, the interface binding solution comprises the interface binding agent and water. The concentration of interface binding agent within the interface binding solution can range from about 0.5% to about 99.5%. In embodiments, the concentration of interface binding agent within the interface binding solution ranges from about 3% to about 98%. The concentration of interface binding agent within the interface binding agent solution can be about 98% or less, about 90% or less, about 80% or less, about 70% or less, about 60% or less, about 50% or less, about 40% or less, about 30% or less, about 20% or less, about 10% or less, or about 5% or less. In one embodiment, the concentration of interface binding agent in the interface binding agent solution is between about 50% and about 10%. In embodiments, the final concentration of interface binding agent within the interface binding agent solution ranges from about 0.1 wt. % to about 30.0 wt. %. In certain embodiments, the final concentration of interface binding agent within the interface binding agent solution ranges from about 0.5 wt. % to about 5.0 wt. %.

In embodiments, the interface binding solution can be directly applied onto the surface of OSB (or wood-based composites) prior to coating a panel with the cementitious slurry coating, blended into the cementitious slurry (such as a fire-resistant coating) to form a cementitious binding agent slurry, or a combination thereof. When blending the interface binding agent or interface binding agent solution with the cement slurry, the interface binding agent, the interface binding agent solution, or both can be added to the cement slurry at different orders of addition to form the cementitious binding agent slurry. In embodiments, the final concentration of interface binding agent within the cementitious binding agent slurry ranges from about 0.1 wt. % to about 30.0 wt. %. In certain embodiments, the final concentration of interface binding agent within the cementitious binding agent slurry from about 0.5 wt. % to about 5.0 wt. %.

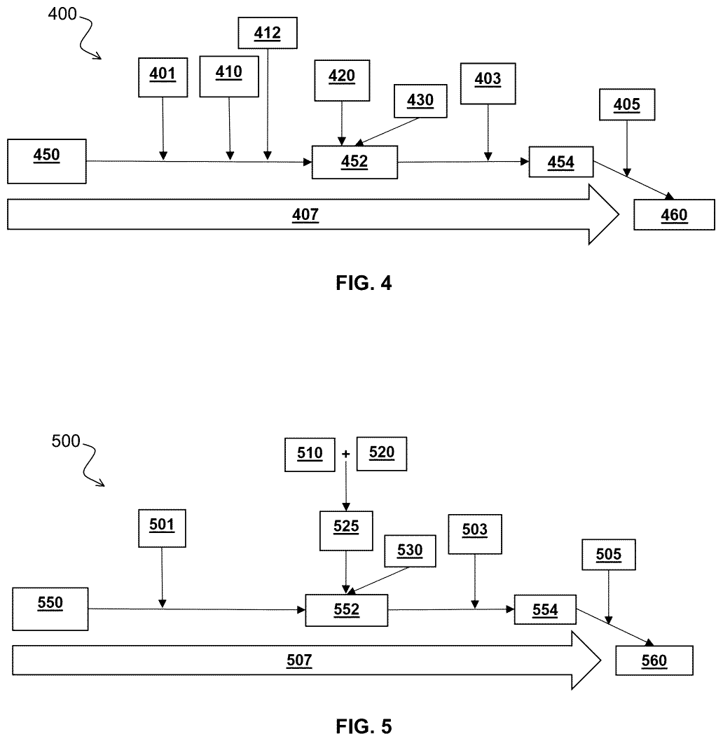

FIG. 4 provides a schematic flow diagram showing an exemplary process for creating a coated building panel 460 with a durable bonding between the lignocellulosic substrate 450 and cementitious coating 420 using the presently disclosed inorganic-organic complex binding system 400 disclosed herein. In this embodiment, a lignocellulosic substrate 450 is placed on a conveyor belt 407. In some embodiments, at least one surface of the lignocellulosic substrate 450 undergoes an optional pretreatment step 401. Such a pretreatment step can include scuffing, embossing, puncturing (e.g., via pneumatic needle gun), sanding, chemical treatment, thermal treatment, or the like. Alternate embodiments do not include the pretreatment step 401. A binding agent 410 can be deposited onto at least one surface of the lignocellulosic substrate 450. In such embodiments, after deposition of the binding agent 410, the lignocellulosic substrate 450 undergoes a coating curing period 412 for a period of time sufficient to permit the binding agent 410 to cure or dry on the at least one surface of the lignocellulosic substrate 450.

Following deposition of the binding agent 410, a cementitious coating 420 can be deposited over the binding agent 410 to create a coated lignocellulosic substrate 452. In certain embodiments, rather than depositing the cementitious coating 420 directly onto the binding agent 410 and lignocellulosic substrate, the cementitious coating 420 is deposited onto an optional layer of reinforcing additives and fillers 430. Following deposition of the cementitious coating 420, the coated lignocellulosic substrate 452 is subjected to a coating curing period 403, for a period of time sufficient to permit the cementitious coating 420 to cure or dry on the at least one surface of the coated lignocellulosic substrate 452 to create a coated binding panel 454. The coated building panel 454 can then undergo processing (e.g., stacking, labeling, shipping, or a combination thereof) to form a final building panel product 460.

FIG. 5 provides a schematic flow diagram showing an exemplary process for creating a coated building panel 560 with a durable bond between the lignocellulosic substrate 550 and cementitious coating 520 in another embodiment of disclosed inorganic-organic complex binding system 500. In this embodiment, a lignocellulosic substrate 550 is placed on a conveyor belt 507. In some embodiments, at least one surface of the lignocellulosic substrate 550 undergoes an optional pretreatment step 501. Alternate embodiments do not include the pretreatment step 501. A binding agent 510 is mixed with a cementitious coating 520 to form a cementitious binding agent slurry 525. The cementitious binding agent slurry 525 can be deposited to at least one surface of the lignocellulosic substrate 550 to create a coated lignocellulosic substrate 552. In certain embodiments, rather than depositing the cementitious binding agent slurry 525 directly onto lignocellulosic substrate 550, the cementitious binding agent slurry 525 is deposited onto an optional layer of reinforcing additives and fillers 530. In certain embodiments, the lignocellulosic substrate 550 is treated with an initial deposition of binding agent 510 (such as via deposition of a wet, binding agent solution) directly onto the at least one surface of the lignocellulosic substrate 550.

Following deposition of the cementitious binding agent slurry 525, the coated lignocellulosic substrate 552 is subjected to a coating curing period 503, for a period of time sufficient to permit the cementitious binding agent slurry 525 to cure or dry on the at least one surface of the coated lignocellulosic substrate 552 to create a coated binding panel 554. The coated building panel 554 can then undergo processing (e.g., stacking, labeling, shipping, or a combination thereof) to form a final building panel product 560.

In embodiments, the binding agent curing period 412, 512 can last as little as one second. The binding agent curing period 412, 512 can last up to about 12 hours. The binding agent curing period 412, 512 can be over 24 hours. In certain embodiments, the binding agent curing period 412, 512 is less than 8 hours. The binding agent curing period 412, 512 can be between about 5 seconds and 8 hours. In various embodiments, the duration of the binding agent curing period 412, 512 is about 5 seconds, about 10 second, about 15 seconds, about 20 seconds, about 25 seconds, about 30 seconds, about 35 seconds, about 40 seconds, about 50 seconds, about 55 seconds, or about 60 seconds.

In embodiments, the coating curing period 403, 503 can last up to about 12 hours. The coating curing period 403, 503 can less than one hour. In certain embodiments, the coating curing period 403, 503 is less than 8 hours. The coating curing period 403 can be up to about 4 hours. In certain embodiments, the coating curing period 403 is between about 15 minutes and 3 hours. In various embodiments, the duration of the coating curing period 403 is about 10 minutes, about 20 minutes, about 30 minutes, about 40 minutes, about 50 minutes, about 60 minutes, about 70 minutes, about 80 minutes, about 90 minutes, about 100 minutes, about 110 minutes, about 120 minutes, about 130 minutes, about 140 minutes, about 150 minutes, about 160 minutes, about 170 minutes, or about 180 minutes.

In embodiments, application of heat can accelerate the binding agent coating period 410, the coating curing period 403, or both. In one example, a substrate spends about 2 minutes inside of the oven in order to initiate either curing process. Thus, depending on the length of the oven, the speed at which the substrates move can be adjusted to satisfy the dwell time requirement. The curing processes following application of the interface binding agent, the cementitious coating, or both need not be fully completed before exiting an oven area. Instead, the exposure to heat initiates and accelerates the curing processes. It is desirable to cure a coating layer gradually once curing has been initiated, because (in general) the longer the wet, interface binding agent or cementitious coating is in contact with the substrate, the deeper the material bond becomes. However, a cure that is too slow causes a slowdown in production. Therefore, controlling the amount of time the coated panel is exposed to curing initiation temperatures, i.e., in a heated oven, may allow for the curing process to proceed at a desired rate while also achieving a strong material-substrate bond, i.e., a bond that is strong enough to hold-up over time and use, particularly following extend exposure to moisture. By way of example, the following coating with an interface binding agent, a cementitious coating, or both the coated substrates are cured over a period of about 3 hours after being exposed to oven heat for a short period of time, e.g., 2-4 minutes. In one embodiment, the amount of heat delivered is measured by measuring the surface temperature of the top of a coated substrate in the oven area. For example, a minimum surface temperature of about 150-175 degrees F. (65-80 degrees C.) can be desirable to initiate cure. In another embodiment, the amount of heat delivered is determined by measuring the btu's per square unit of area delivered during the time a coated substrate passes through the oven. For example, it has been found that a minimum btu amount of about 5,000 btu's per square foot is desirable to initiate cure.

Alternatively, no heating period is used. In certain embodiments, mixing an interface binding agent with a cementitious coating (also referred to herein as forming a cementitious binding agent) eliminates or reduces the need for pre-heating of a coated substrate. In embodiments, the time required for curing a cementitious binding agent coating (with or without heating) is less than time required for curing a cementitious coating that does not comprise a binding agent. The curing process can occur at room temperature. In certain embodiments, incorporating an interface binding agent into the cementitious coating accelerates the curing of the fire-resistant material at room temperature compared to a fire-resistant cementitious coating without such an agent.

Although a convey belt 407, 507 is shown in the embodiments of FIGS. 4 and 5, it should be understood that the disclosed system can also be accomplished in the absence of a conveyor belt 407, 507. For example, in certain embodiments, a human user, a machine, or both can perform any one or more of the building panel processing steps or deposit one or more layers while the lignocellulosic substrate 450, 550 remains stationary.

In addition, the systems and methods disclosed herein include the deposition of more than one layer of fire-resistant cementitious coatings onto a lignocellulosic substrate coated with an interface binding agent (either by pretreatment of the lignocellulosic substrate with an interface binding agent, intermixing the interface binding agent into the first layer of cementitious, fire-resistant material, or a combination thereof). By way of example, following a first deposition of fire-resistant material onto a lignocellulosic substrate (as disclosed, for example in FIGS. 4 and 5), a second deposition of fire-resistant material can be added over the first deposited layer of fire-resistant material. Certain methods can comprise adding a third, fourth, fifth, or sixth layer of fire-resistant material over the preceding layer. In embodiments, a coating curing period is performed following the deposition of at least one layer of fire-resistant material. A coating curing period can be performed following deposition of at least two layers of fire-resistant material. In certain embodiments, a coating during period is performed following each deposition of fire-resistant coating. Any of the various layers can be added according to an of the deposition methods disclosed herein (e.g., deposited by roll coating, flow coating, spray coating, or any other method known in the art). When heat is applied to the layers of fire-resistant-substance, infrared radiation may be used in order to initiate a penetrating curing process of the layers of fire-resistant material. In some embodiments, the applied heat source is removed, and the heated layers of fire-resistant substance are allowed to cure. Alternatively, the substrate may be removed from heat and a finishing layer may be applied over a coated portion of the substrate. An additional layer may be applied over the third layer of fire-resistant material which may include, for example, another substrate, wood veneer, laminates, paper and plastic film.

According to certain embodiments of the present invention, a substrate to be coated with an interface binding agent (whether directly applied to the platen surface of the substrate, admixed with a fire-resistant coating, or both) can be pre-treated to increase the bonding area of the substrate available at the microscopic level and to roughen the surface. The increased bonding area provides an increased amount of available surface for the interface binding agent to adhere. This may be particularly useful for composite lignocellulosic materials formed with pressure and/or heat with releasing agents that have resulting smooth surfaces. Non-limiting pretreatment methods include scuffing, sanding, and introducing substrates to a chemical bath, each of which increases the substrate available bonding area. Briefly, when lignocellulosic material is subjected to such treatments, interstitial spaces open to increase the porosity and permeability of the lignocellulosic surface. This permits increased penetration by interface binding agents, such as those disposed in an interface binding agent solution. In addition to opening interstitial spaces in lignocellulosic material, scuffing can create a surface toothing allowing for increased physical bonding with the interface binding agents. This is because as an interface binding agent solution (wither directly deposited onto a surface of the substrate or applied after admixing with a fire-resistant cementitious coating) cures and dries it adheres more strongly to a rough surface, as compared to a smooth surface.

Various application methods may be used, including, but not limited to, the following: (1) direct application of a interface binding agent onto the platen surface of a lignocellulosic panel (with or without pre-treatment, such as scuffing or sanding); (2) addition of the interface binding agent (whether as a solution or as mixed solids) into the cement slurry mix, with different orders of addition for multiple agents, before coating of the lignocellulosic panel with the cement slurry; or (3) direct application of the interface binding agent onto the platen surface of a lignocellulose-based panel followed by application of a cement slurry mix that also comprises an interface binding agent.

In various embodiments, the method of applying the interface binding agent solution, the cement slurry mix, or both can be dip coating, spraying, brushing, roll coating, spin coating, flow/curtain coating, or similar application methods. The method of applying the coupling agent, the cement slurry mix, or both can comprise any method disclosed in U.S. Pat. No. 7,95,092, the entirety of which is incorporated herein by reference.

Coating substrates with the interface binding agent solution, the fire-resistant materials, or both (also referred to herein as a “flowable material) according to the present processes, includes depositing flowable or viscous layers of a homogenous mixture (often called a slurry) onto a substrate. For example, one or more rollers, flow coaters, or sprayers may be used as vehicles to deposit a layer of solution or slurry on a scuffed or non-scuffed substrate. In one example, when the substrate is passed between a feed roll and a coating roller, the flowable material is deposited onto the substrate. The thickness of the layer of flowable material deposited may be controlled by adjusting the mechanical features of the coating machine such as the nip, e.g., the distance between rollers, and the speed at which the rollers rotate. For reverse roll coaters, for example, the coating roller deposits more material as it rotates faster and vice-versa. In addition, the thickness of the layer of flowable material may be controlled by controlling the pressure one or more rollers exerts on a coated substrate. The thickness of the finished layer of fire-resistant material cab be about 0.010 inches to about 0.125 inches or about 10 to about 125 mils. Depositing an initial slurry of fire-resistant material on the entire surface of a substrate serves as a wetting step to set up a strong, continuous bond between the substrate and the fire-resistant material, e.g., between cells on a wood substrate and a slurry. Complete wetting of the surface is desirable to begin the penetration process of the fire-resistant material into the substrate. A strong bond between the board and the fire-resistant material also improves the foundation for layers that are subsequently deposited. Without wetting of the substrate surface, any additional layers deposited on the substrate may bond to it less strongly.

Additionally or alternatively, fire-resistant material may be deposited on, or may impregnate or coat, a web or veil of carrier material (seen at 130 of FIG. 1), which may subsequently be deposited over a substrate. For example, one or more rollers, flow coaters, or sprayers may be used as devices to deposit fire-resistant material on a veil material. Additionally, a pan bath may be used to impregnate a veil material. Veil material may include a variety of pliable and porous fabrics such as woven or spunbound fiberglass, polyester, nylon, wool, carbon steel, or other fiber or filament materials suitable for receiving viscous fire-resistant coating. Preferably the veil material is available in a continuous roll several hundred feet long and at least as wide as the entire substrate (typically four feet), so that a continuous feed of a single web of coated carrier material onto the substrate may occur. Alternatively, the veil material may be slightly narrower than the width of the panel for use with panels having beveled edge-treatment, for example.

In various embodiments, the systems and methods disclosed herein provide improvements in the one or more of the following: (1) dry and wet bonding performance between a cementitious coating and an organic substrate; (2) water resistance of the finished building panel product with reduced thickness swell and water absorption; (3) a cement mass retention of the building panel after water immersion; (4) flatness of the building panel product surface; and (5) flame retardancy of the building panel following curing/hardening of the cement coating.

### EXAMPLES

Examples are provided below to facilitate a more complete understanding of the invention. The following examples illustrate the exemplary modes of practicing the invention. However, the scope of the invention is not limited to specific embodiments disclosed in these Examples, which are for purposes of illustration only, since alternative methods can be utilized to obtain similar results.

### Example 1

In one exemplary embodiment, the silane coupling agents, the silicate sealers, or both are directly applied onto the surface of OSB (or wood composite) panels before cement slurry coating. Applying method may be spraying, brushing, rolling, curtain coating, or the like. OSB surface texture may be rough (scuffed, embossed, acupunctured by pneumatic needle gun, or the like), smooth (sanded or chemically/physically/thermally treated), or “as-is” after the hot-pressing process.

When applied onto the surface of wood or wood-based composites followed by slurry coating, liquid silicates can penetrate the cell wall of wood or wood-based composites to form larger particles and solid adhesive bonds by the loss of water or by a chemical setting mechanism. A condensation reaction can occur between silicic acid and functional groups containing oxygen or nitrogen heteroatoms (such as hydroxyl groups, carboxylic acids, primary or secondary amine/imine and the like) in the plant cell wall during curing, dying, pH adjustment (from alkaline to acidic environments) or a combination thereof. In addition or in the alternative, the alkali silicates can synergistically react with minerals in the coating slurry (after applied) to produce solid and insoluble bonds to enhance the interface bonding strength.

Certain embodiments can comprise a pre-activation step. The pre-activation step can comprises mixing the silane coupling agents, the silicate sealers, or both with water under stirring for about 0.5 to about 5.0 hours to obtain the solution at concentration ranging from about 5% to about 95% before applying the mixture onto the OSB (or wood composite panels) surface. Alternatively, instead of pre-activation, the silane coupling agents, the silicate sealers, or both agents are used “as-is” without mixing with water.

### Example 2

In certain embodiments, the silane coupling agents, the silicate sealers, the siliconate penetrating sealers, or any combination thereof can be added into the cement slurry mix at varying orders of addition before coating the mixture onto the surface of OSB (or wood composite panels). When blended into a coating slurry, the alkali silicates or siliconates can react chemically with minerals (e.g., calcium, aluminum, magnesium containing salts etc.) present within the coating slurries such that, after application and following a curing period, the cured coatings are stronger while simultaneously blocking or reducing the passage of water, salts, and gases through the concrete or fire-resistant coating. The silane coupling agents, the silicate sealers, the siliconate penetrating sealers, or any combination thereof can be added with solid components or liquid additives or water of cement slurry formula, or in the end of slurry mixing, or blended with well mixed slurry in a separate container before coating onto OSB panels.

This method is a simpler process than Example 1. It also may (1) improve the cement surface flatness to minimize pinholes and/or craters, (2) offer an anti-slip surface, (3) speed up cement curing/hardening, and (4) enhance the water resistance of the finished product.

Example 3: Pneumatic Adhesion Tensile Testing Instrument (PATTI) Testing Objective: Because panels are often exposed to the elements during construction, customers require a durable panel with a bond that is able to resist minor moisture exposure. The presently disclosed PATTI test quantifies the bond strength between a coating, such as a cementitious coating or a FR coating) and a building panel.

### Equipment Required:

1. A machine for testing the tensile strength of materials (e.g., an Instron® Machine (Illinois Tool Works, Inc., Illinois, USA)) and 2″ metal pull-stub testing blocks (also referred to herein as aluminum P.A.T.T.I.® Blocks (SEMicro Corp., Maryland, USA)).
2. Hot plate capable of heating PATTI test blocks to melt hot glue
3. A 2″ ceramic hole saw and drill or drill press
4. Tape measure
5. Permanent marker
6. Panel saw

### Specimen Preparation:

1. Obtain a sample building panel with a cementitious coating disposed thereon.
2. Label each specimen as to the thickness, date, and time the product was stamped. If 2-sided product is being tested, label which side is the 1st side and the 2nd side coated.
3. Cure samples for at least 24 hours before testing.
4. Using a masonry hole saw, score three 2″ diameter circles through the coating building panel to create 3 separate, 2″ diameter circular testing areas, the external border of each testing area being defined by the scoring. The scoring should be staggered evenly across the sample starting at ˜1″ from each edge. In preferred testing embodiments, the scoring is sufficiently deep to traverse completely through the cementitious coating and the interface binding layer with minimal penetration into the lignocellulosic substrate portion of the panel. When properly scored, an isolated, circular testing area is established in the portion of the building panel that is medial to each score line.
5. Place the pull-stub testing block on a hot plate.
6. Set the hot plate to a temperature that is sufficient to warm the pull-stub testing block to a temperature that is sufficient to melt hot glue on the upward-facing surface of the pull-stub testing block (˜220 deg C.).
7. After heating, place an amount of hot glue that is sufficient to cover the entire upward-facing surface of the pull-stub testing block.
8. After the glue melts, place the surface of the pull-stub testing block that contains the melted glue over a circular testing area of the building panel sample while avoiding deposition of glue onto the scored border of the testing area. For the most accurate results, the hot melt glue should be evenly and thoroughly spread over the entire face each testing are of the sample building panel.
9. Allow the hot glue and test sample to thoroughly cool until a bond is formed between the pull-stub testing block and each testing area of the sample building panel.

### Patti Testing

10. After cooling of the pull-stub testing block and testing areas, insert a ⅜″ blot into the threaded portion of the pull-stub testing block such that the bolt extends upwardly therefrom.
11. Attach the bolt to the tensile-strength testing machine and run tensile testing on each testing area of the sample building panel.
12. REQUIRED STEP FOR WET PATTI TESTING ONLY—Prior to testing, soak the sample building panel for 24 hours. Omit this step for dry PATTI testing.
13. During testing, a continuous upward load is applied to the testing area as the tensile-strength testing machine pulls the pull-stub testing block attached thereto. This load is applied until delamination occurs (e.g., until the cementitious coating is pulled from the lignocellulosic substrate of the building panel).
14. Bond strength is recorded as the psi value obtained at the moment of delamination.

### Results:

As shown in Table 1, below the addition of interface binding agent improved the adhesion between SYP and the cementitious coating, particularly when the interface binding agent was directly applied to the surface of the lignocellulosic substrate.

Briefly, using the wet and dry PATTI tests described above, bonding strength was analyzed between different types of lignocellulosic building panels and Pyrotite® (Louisiana-Pacific Corporation, Tennessee, USA), a cementitious FR coating comprising MOC. Bond strength between the cementitious coating and aspen panels and bond strength between the cementitious coating and SYP panels were determined without the addition of a binding agent.

In addition, bond strength was determined on SYP OSB panels that were either (1) treated with an interface binding agent via direct application of the binding agent to the platen surface of the SYP lignocellulosic substrate prior to addition of the cementitious coating thereon, or (2) treated with a cementitious binding agent slurry, wherein an interface binding agent is mixed with the cementitious coating before the cementitious binding agent slurry is deposited thereon. Andisil 187, an epoxy type of silane coupling agent, was used as the interface binding agent in generating the data of Table 1.

When sprayed directly onto the surface of an SYP OSB panel, Andisil 187 was diluted with water to create an interface binding agent solution that was 50% binding agent by weight. In preparing the binding agent solution, the andisil187 (originally >98% solids) was diluted to create a 50% solution with water in a spray bottle under stirring for between about 30 min to about 3 h before being applied to the OSB surface. When the binding agent was premixed with the cementitious coating to form a cementitious binding agent slurry prior to applying on an OSB surface, the concentration of interface binding agent within the resultant cementitious binding agent slurry was about 0.5 wt. %.

As shown in Table 1, in the absence of an interface binding agent, aspen panels exhibited increased bonding performance as compared to the same coating on SYP, particularly following exposure of the panel to moisture prior to performance of the tensile strength test (Wet PATTI Test-Aspen: ≤18.1 vs. SYP: ≤5.33). Under wet conditions (Wet PATTI Test), the cementitious coating exhibited improved bond strength with the SYP lignocellulosic after application of the interface binding agent directly onto the platen surface of SYP substrate (Wet PATTI Test-SYP pre-treated with an Interface Binding Agent: ≥16.57 psi). As shown, the direct application of an interface binding agent onto the surface of an SYP substrate enables the achievement of a cementitious coating bond strength that is comparable to the bond strength observed with aspen panels.

TABLE 1
Results from PATTI Test

| Control (No | Bond Strength (psi) | | With Interface | Bond strength (psi) | |
|---|---|---|---|---|---|
| Binding Agent) | Dry PATTI | Wet PATTI | Binding Agent | Dry PATTI | Wet PATTI |
| 7/16″ Aspen | ≤37.8 | ≤18.1 | | | |
| OSB Panel | | | | | |
| 7/16″ Southern | ≤39.33 | ≤5.33 | 50 wt. % Interface | 44.93 | 16.57 |
| Yellow Pine | | | Binding Agent Solution | | |
| (SYP) OSB | | | Sprayed on OSB panel | | |
| panel | | | surface prior to cement | | |
| | | | slurry coating (see, e.g., | | |
| | | | FIGS. 3 & 4) | | |
| | | | 50 wt. % Interface | 42.87 | 17.53 |
| | | | Binding Agent Solution | | |
| | | | Sprayed on OSB panel | | |
| | | | surface prior to cement | | |
| | | | slurry coating (see, e.g., | | |
| | | | FIGS. 3 & 4) | | |
| | | | Cementitious Binding | 26.92 | 8.29 |
| | | | Agent Slurry - (0.5 | | |
| | | | wt. % Interface Binding | | |
| | | | Agent Applied after | | |
| | | | Batch Blending) (see, | | |
| | | | e.g., FIGS. 2 & 5) | | |
| | | | 0.5 wt. % Interface | 47.91 | 4.82 |
| | | | Binding Agent Applied | | |
| | | | after Batch blending | | |
| | | | method (see, e.g., FIGS. | | |
| | | | 2 & 5) | | |

Importantly, although the interface binding agent minimally affected bond strength when it was premixed with the cementitious coating, other benefits were observed. For instance, the following improvements were observed after deposition of a blended cementitious binding agent slurry (i.e., a FR cementitious coating with an interface binding agent blended therein) onto a lignocellulose-based building panel: defoaming, thinning of the slurry in hot environment (such as in the summer), smoothing wet/cured cement surface with decreased dimples/pinholes, and speeding up cement curing/hardening.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art. In embodiments, these improvements can be applied to building panels of any lignocellulosic substrate type.

### EQUIVALENTS

Those skilled in the art will recognize, or be able to ascertain, using no more than routine experimentation, numerous equivalents to the specific substances and procedures described herein. Such equivalents are considered to be within the scope of this invention and are covered by the following claims.

What is claimed is:

1. A multi-layered building panel, the multi-layered building panel comprising:
a lignocellulosic substrate layer comprising a first surface;
an interface binding layer comprising an interface binding agent, the interface binding layer being disposed on the first surface of the lignocellulosic substrate and the interface binding agent comprising a silane, a siliconate, an alkali silicate, or a combination thereof; and
a cementitious coating layer disposed over the interface binding layer such that the interface binding layer is disposed between the cementitious coating layer and the first surface of the lignocellulosic substrate layer.

2. The multi-layered building panel of claim 1, wherein the lignocellulosic substrate layer comprises southern yellow pine.

3. The multi-layered building panel of claim 1, wherein the cementitious fire-resistant layer comprises an intermixed interface binding agent, the intermixed interface binding agent comprising a silane, a siliconate, an alkali silicate, or a combination thereof.

4. The multi-layered building panel of claim 3, wherein the concentration of interface binding agent within the interface binding layer is about 50 wt. % or less.

5. The multi-layered building panel of claim 4, wherein the concentration of interface binding agent within the interface binding layer is between about 50 wt. % and 10 wt. %.

6. The multi-layered building panel of claim 1, wherein the lignocellulosic substrate comprises a second surface, the multi-layered building panel further comprising:
a second interface binding layer comprising the interface binding agent, the second interface binding layer being disposed on the second surface of the lignocellulosic substrate; and
a second cementitious coating layer disposed on the second interface binding layer such that the second interface binding layer is disposed between the second cementitious coating layer and the second surface lignocellulosic substrate layer.

7. The multi-layered building panel of claim 6, wherein the lignocellulosic substrate layer comprises southern yellow pine.

8. The multi-layered building panel of claim 6, wherein the cementitious fire-resistant layer comprises an intermixed interface binding agent, the intermixed interface binding agent comprising a silane, a siliconate, an alkali silicate, or a combination thereof.

9. The multi-layered building panel of claim 1, wherein the cementitious fire-resistant coating comprises magnesium oxychloride.

10. The multi-layered building panel of claim 1, wherein the cementitious fire-resistant coating is disposed within a carrier veil web.

11. A multi-layered fire-resistant lignocellulosic panel, comprising:
a first layer, wherein the first layer comprises a lignocellulosic substrate;
a second layer wherein the second layer comprises a cementitious binding agent slurry, the cementitious binding agent slurry comprising:
a cementitious fire-resistant coating and an interface binding agent,
the interface binding agent comprising a silane, a siliconate, an alkali silicate, or a combination thereof.

12. The multi-layered fire-resistant lignocellulosic panel of claim 11, further comprising a third layer that comprises an interface binding layer, the interface binding layer being disposed between the first and second layers, the interface binding layer comprising a silane, a siliconate, an alkali silicate, or a combination thereof.

13. The multi-layered fire resistant lignocellulosic panel of claim 11, wherein the concentration of interface binding agent within the second layer is less than about 5 wt. %.

14. The multi-layered fire resistant lignocellulosic panel of claim 13, wherein the concentration of interface binding agent within the second layer is less than about 1 wt. %.

15. The multi-layered fire resistant lignocellulosic panel of claim 11, wherein the lignocellulosic substrate layer comprise southern yellow pine.

16. The multi-layered fire resistant lignocellulosic panel of claim 11, wherein the cementitious fire-resistant coating comprises magnesium oxychloride.

17. The multi-layered fire resistant lignocellulosic panel of claim 11, wherein the cementitious fire-resistant coating is disposed within a carrier veil web.

18. A method of creating a lignocellulosic panel with a cementitious coating that is resistant to delamination, the method comprising:
depositing an interface binding layer onto at least one surface of the lignocellulosic panel, the interface binding layer comprising an interface binding agent and the interface binding agent comprising a silane, a siliconate, an alkali silicate, or a combination thereof;
depositing a cementitious coating layer over the interface binding layer such that the interface binding layer is disposed between the cementitious coating layer and the lignocellulosic panel; and
permitting the cementitious coating layer to cure onto the lignocellulosic panel.

19. The method of claim 18, wherein the lignocellulosic panel comprises southern yellow pine.

20. The method of claim 18, wherein the cementitious coating layer comprises an intermixed interface binding agent, the intermixed interface binding agent comprising a silane, a siliconate, an alkali silicate, or a combination thereof.
